(19) United States
(12) Patent Application Publication
(10) Pub. No.: US 2009/0037373 A1
(43) Pub. Date: Feb. 5, 2009

(54) Method and System for Management and Publication of Media Assets in a Distributed Network

(76) Inventor: Les Gilbert, Hawthorn (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/573,424

(22) PCT Filed: Sep. 24, 2003
(86) PCT No.: PCT/AU03/01258

§ 371 Date: Sep. 26, 2008

(51) Int. Cl. G06F 7/06; G06F 17/30

(52) U.S. Cl. 707/3; 707/10; 707/E17.014; 707/E17.032

(57) ABSTRACT

A system (1) for management and publication of media assets (102.3) in a distributed network (205). The system includes: a central media database (101) for storing and serving the media assets (102.3) and media programs (102.2) for publication of the media assets; one or more output platforms (117, 118) networked to the central media database; and one or more media output devices (103-106) networked to the one or more output platforms. Each output platform stores a local copy of a subset of the media assets and a subset of the media programs, and selectively executes the subset of media programs to publish the subset of media assets at the one or more media output devices.

The present invention relates generally to a system and method for storing and serving media assets, such a multi-media information, to one or more media output devices in a distributed computer network. The invention is suitable for use in multi-media systems installed in museums, libraries and other public facilities in which selected multi-media content is displayed to members of the public. It will be appreciated, however, that the invention is not limited to this exemplary application.

Current multi-media display systems typically involve the centralised storage of media assets at a media asset database, and the use of one or more associated peripheral devices for the distribution of multi-media content to users. The wide spread use of multi-media display systems, and the ever increasing demands for data storage, processing speed, system functionality and inter-operability, have resulted in existing client-server multi-media display systems being found to be inadequate in a number of areas.

Notably, existing multi-media assets of a single facility are typically spread across multiple multi-media display systems, resulting in decreased accessibility and increased asset maintenance costs. It is difficult for multiple systems to collaborate and share resources and functionality. It is also difficult to store, manage and serve multi-media content at a wide variety of multi-media display devices providing content to users within a single facility, and is even more difficult when a number of facilities wish to share multi-media information. Limited or no content management which would allow the modification of content and the delivery format of the content for display is provided. There is moreover no capability to transparently publish multi-media content in different formats and resolutions to accommodate different multi-media display devices.

It would therefore be desirable to provide a method and system for publication of media assets in a distributed network that provides for powerful and flexible storage, management and/or serving of multi-media content and other media assets to a number of different media output devices.

It would also be desirable to provide a method and system for management and publication of media assets in a distributed network that ameliorates or overcomes one or more problems of known media asset and management and publication systems and methods, or at least provides an alternative to existing systems and methods.

With this in mind, one aspect of the present invention provides a system and management and publication of media assets in distributed network, the system including:

a central media database for storing and serving the media assets and media programs for the publication of the media assets;

one or more output platforms networked to the central media database; and

one or more media output devices networked to the one or more output platforms, each output platform storing a local copy of a subset of the media assets and a subset of the media programs, and selectively executing the subset of media programs to publish the subset of media assets at the one or more media output devices.

A media asset management and publication system including these features advantageously centralises the storage of the multi-media assets of a facility, whilst decentralising the processing power required to display those multi-media assets at a variety of media output devices. Such a system is scalable and easily adaptable to the publication needs of museums and other facilities.

Preferably, the central media database includes a content manager for uploading the media assets. The content manager may enable searching and selection of the subset of media assets and the subset of media programs, and the assignment of the subset of media assets and the subset of media programs to the one or more output platforms. The content manager may typically be accessible from a browser-based user interface.

Each of the one or more output platforms may include a dynamic display engine for delivery of media output, derived from the subset of media assets and execution of the subset of media programs, to the one or more media output devices.

The central media database may further include an output platform update server for determining if the stored subset of the media assets and/or media programs have changed when comparing to the local copy stored on each output platform, and, when a change is detected, serving updated media assets and media programs to the one or more output platforms.

Each of the one or more output platforms may further include an output platform manager for initiating a request with the output platform server to update the locally stored subset of the media assets and/or media programs.

The output platform manager may include a multiformat subcomponent for producing reformatted versions of the media assets for simultaneous, parallel publication at the media output devices.

The central media database and the one or more output platforms may both include a file synchronisation manager for effecting the serving of media assets and/or media programs between the central media database and the one or more output platforms.

At least one of the one or more output platforms may be a local output platform connected to the central media database from a local installation site.

Alternatively, or additionally, at least one of the one or more output platforms may be a remote output platform connected to the central media database from a remote installation site.

The central media database may further include a media asset replicator for sharing stored media assets and/or media programs with a further media asset management and publication system.

An external media asset manager may be connected to the distributed network for providing remote access to the stored media assets.

The system may further include one or more distributed terminals connected to the distributed network for providing local access to the stored media assets.

The system may include a web server connected to the one or more output platforms for providing web-based access to the stored media assets. A web extension module, accessible via the web server, may be provided for maintaining extended media information about the stored media assets.

In the context of the present invention, the media assets may include any one or more of image, text, video and audio content, or any other media or multi-media content.

Automatic sensing devices may be connected to the distributed network for automated triggering of media publication at the media output devices. The automatic sensing devices may include any one or more of a motion sensor, pressure pad or any other automated sensor.

The system may further include user input devices connected to the distributed network to enable user interaction with the published media. The user input devices may include any one or more of a smart card, touch screen display, hand held computing device, mobile phone, braille touchpad or other suitable device.

Another aspect of the invention provides a method for management and publication of media assets in a distributed network. The method including the steps of:

(a) storing and serving the media assets and media programs for publication of the media assets in a central media database;

(b) at one or more output platforms networked to the central media database, storing a local copy of a subset of the media assets and a subset of the media programs; and

(c) selectively executing the subset of media programs to publish the subset of media assets at one or more media output devices networked to the one or more output platforms.

The central media database may include a content manager. In this case, the method may further include the step of uploading the media assets to a central media database.

The method may also include the steps of enabling searching and selection of the subset of media assets and the subset of media programs from the content manager; and assigning the subset of media assets and the subset of media programs to the one or more output platforms from the content manager. The method may also include the step of accessing the content manager from a browser-based user interface.

Each of the one or more output platforms may include a dynamic display engine. In this case, the method may further include the step of delivering media output, derived from the subset of media assets and execution of the subset of media programs, to the one or more media output devices from the dynamical display engine.

The central media database may further include an output platform update server. In this case, the method may further include the steps of at the output platform update server, determining if the stored subset of the media assets and/or media programs have changed when compared to the local copy stored on each output platforms; and

When a change is detected, serving updated media assets and media programs to the one or more output platforms.

Each of the one or more output platforms may include an output platform manager. In this case, the method may further include the step of at the output platform manager, initiating a request with the output platform update server to update the locally stored subset of the media assets and/or media programs.

The method may further include producing reformatted versions of the media assets for simultaneous, parallel publication at the media output devices

The central media database and the one or more output platforms may both include a file synchronisation manager. In this case, the method may further include the step of effecting the serving of media assets and/or media programs between the central media database and the one or more output platforms from the file synchronisation managers.

The central media database may include a media asset replicator. In this case, the method may further include the step of, at the media asset replicator, sharing stored media assets and/or media programs with a further media asset management and publication system.

The method may further include the step of providing remote access to the stored media assets from an external media asset manager connected to the distributed network.

The method may further include the step of providing local access to the stored media assets from one or more distributed terminals connected to the distributed network.

The method may further include the step of providing web-based access to the stored media assets from a web server. The method may also include the step of maintaining extending media information about the stored media assets accessible via the web server from a web media extension module.

The method may further include the step of automatically triggering media publication at the media output devices from automatic sensing devices connected to the distributed network.

The method may further include the step of enabling user interaction with the published media from user input devices.

The following description refers in more detail to the various features of the present invention. To facilitate an understanding of the invention, reference is made in the description to the accompanying drawings where the method and system for management and publication of media assets in a distributed network is illustrated in a preferred embodiment. It is to be understood that the invention is not limited however to the preferred embodiment illustrated in the drawings.

In the drawings:

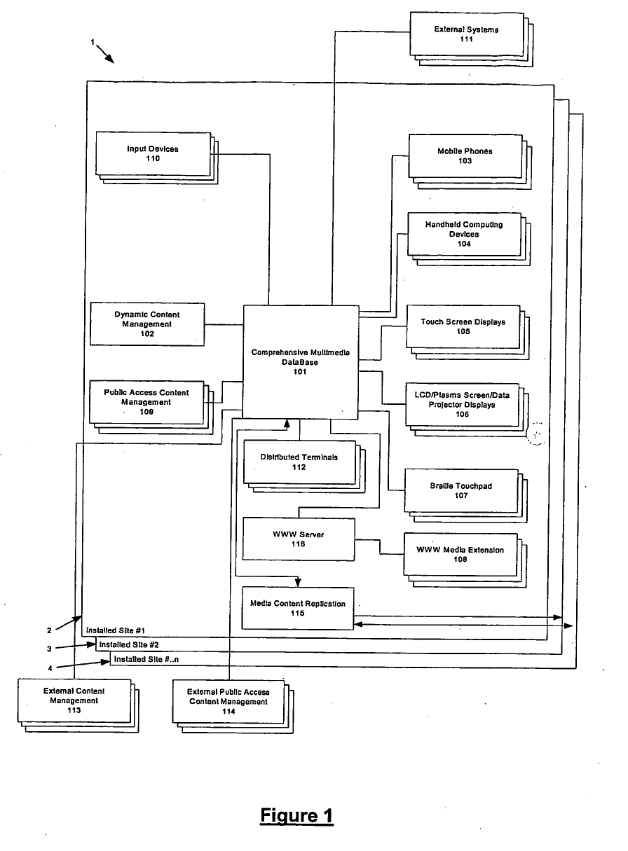

FIG. 1 is a schematic diagram illustrating the system architecture of one embodiment of a media asset management and publication system according to the present invention;

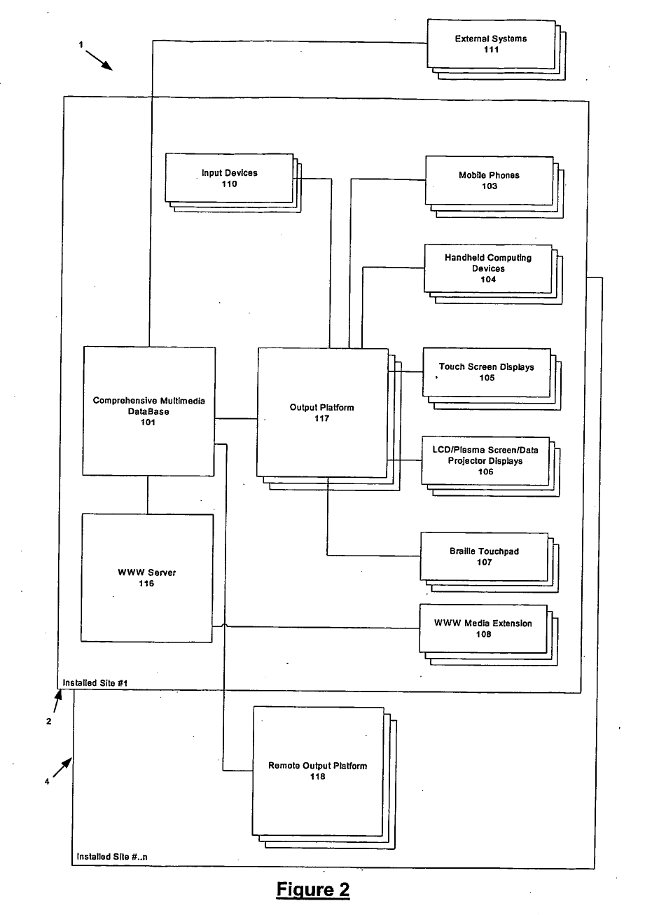

FIG. 2 is a schematic diagram showing in more detail the architecture associated with the delivery of multi-media content by the system shown in FIG. 1;

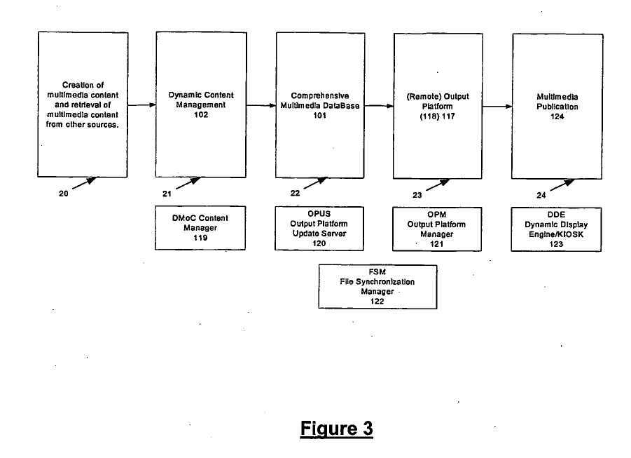

FIG. 3 is a flow chart depicting the steps taken by the system of FIG. 1 in the uploading management and display of multi-media content by media output devices;

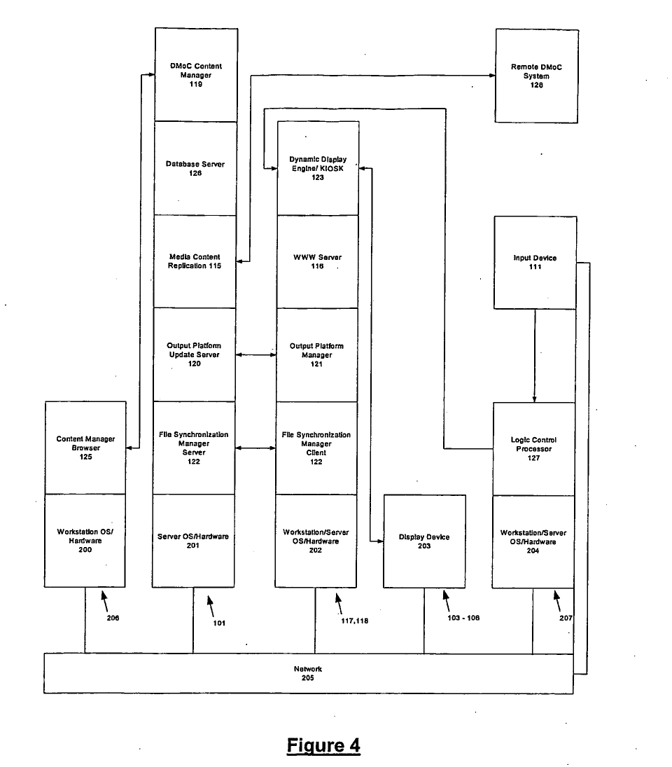

FIG. 4 is a schematic diagram depicting the architecture of the major software components forming part of the system of FIG. 1;

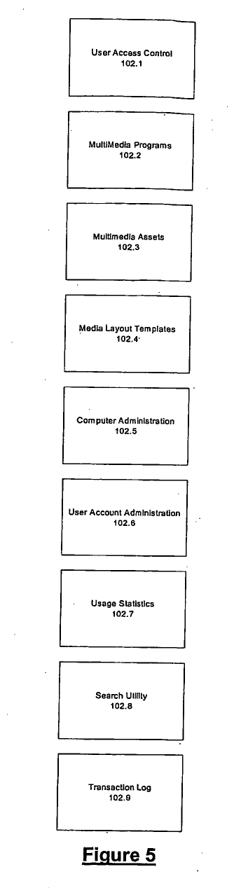

FIG. 5 is a schematic diagram depicting the major functional components of the content manager forming part of the system shown in FIG. 1; and

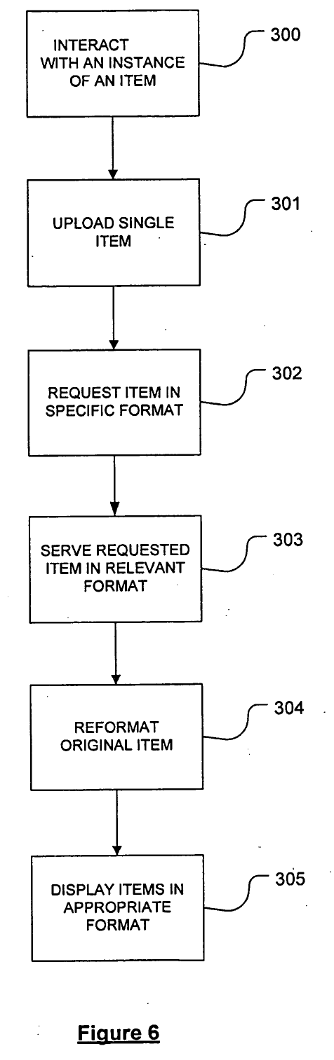

FIG. 6 is a flow chart depicting the steps taken by the system of FIG. 1 in the simultaneous parallel publishing of media content to media output devices.

Referring now to FIG. 1, there is shown generally a media assets management and publication system 1 in accordance with one embodiment of the present invention. The system 1 includes a central media database 101 for storing and serving media assets and media programs for publication of the media assets. The media database may be implemented with any suitable database management system in conjunction with a host computer's file system. Typically a Relational Database Management System (RDBMS), such as the Interbase RDBMS manufactured by Borland™, may be used running on a dedicated computer server.

A dynamic content manager 102 is operatively connected to the central media database 101. The content manager 102 enables the searching of and uploading of media assets, such as image, text, video and audio content, and other media or other multi-media content, to the central media database 101.

The system 1 supports the simultaneous parallel publishing of media assets maintained in the central media database 101 within interactive or non-interactive media programs to a number of different interactive or passive media output devices. Such media output devices include mobile phones 103, hand held computing devices 104, touch screen displays 105, LCD/plasma screen/data projector displays 106 and a web media extension module 108. The hand held computing devices 104 may be networked to the system 1 through devices such as a wireless Internet connection or a blue tooth connection.

One or more user input devices are also networked to the system 1 to enable user interaction with the media published at the media output devices 103 to 106. These user input devices may include such devices as a smart card, a braille touchpad 107, the touch screen display 105, hand held computing device 104, mobile phones 103 and the web media extension module 108.

Automatic sensing devices 110 are also networked to the system 1 for automated triggering of media publication or the provision of other functionality, at the media output devices 103 to 106 in the presence of a user audience. Such automated sensing devices include motion sensors, pressure pads and pressure plates.

The above described elements of the system 1 are installed at a first local installation site 2. For example, the installation site 2 may be a museum, art gallery or other like facility. One or more distributed terminals 112 are connected to the system 1 at the local installation site 2 to enable the stored media assets to be accessed by the professional staff of the facility in question. This enables the media assets to function as research and development collections in addition to forming the basis of media displays at the media output devices 102 to 106. This also creates an infrastructure for the distributed access to a single storage system for all media assets of the facility.

The system 1 may include a number of system elements installed at other remote installation sites. FIG. 1 depicts two such exemplary remote installation sites, referenced 3 and 4.

The system 1 also provides support for remote media content replication via the media asset replicator 115. By enabling the replication of at least some of the media assets maintained by the system 1, the media assets replicator 115 enables the sharing of stored media assets and/or media programs with further media asset management and publication systems.

A web server 116 is networked to the system 1 to provide web-based access to the stored media assets maintained in the system. The web server 116 enables a facility to use the system 1 to host a web presence where the multi-media assets of the system 1 can be viewed over the Internet. The web media extension module 108 is accessible via the web server 116, and maintains extended media information about the stored media assets. In this way, an Internet audience is able to view published information via the web server 116 relating to the media assets hosted by the system 1.:

The system 1 may also be networked with one or more external systems 111, such as other multi media display systems or legacy storage systems. This enables the system 1 to be integrated with existing systems or with other multi-media display systems to which the display of multi-media assets can be delegated.

A public access content management module 109 is provided to enable limited and moderated public access to the media assets maintained in the system 1. This enables some users restricted and limited access to at least a defined subset of the media assets to allow creation, deletion and modification of those assets, and their placement within either interactive or non-interactive multi-media displays. The module 109 enables the system 1 to support public access to personalise the multi-media displays. Moderated access requires there to be a time lag to enable human intervention and vetting of the media assets before any public initiated changes are propagated to the media output devices. The public access content management module 109 may be hosted by a web server and accessible to users via a suitable web browser.

The system 1 also supports external, remote access from staff employed by the facility in which the system 1 has been installed, via an external content management module 113, as well as providing general public user access via an external public access content management module 114.

The media asset management and publication system 1 provides support for the scalable implementation of multi-media displays. In other words, the system 1 can be grown to support many individual multi-media displays, and the displays can show any amount of multi-media data within complex interactive or non-interactive multi-media programs. The system 1 introduces the use of output platforms to provide for the scaling implementation of the multi-media displays.

FIG. 2 illustrates two exemplary output platforms, namely a local output platform 117 and a remote output platform 118. The local output platform 117 stores a local copy of an assigned subset of the media assets maintained in the central media database 101. The output platform 117 executes one or more media programs which display the associated media assets via a specific multi-media display device such as the mobile phone 103, hand held computing device 104, touch screen display 105 or LCD/plasma screen/data projector display 106. The use of the output platform 117 enables any number of multi media displays to be hosted by the system 1. As the processing power required to support the multi-media displays is not provided by the central media database. The media asset management and publication system 1 centralises the storage of the media assets in the central media database 101, but decentralises the processing power required to display the media assets to the one or more output platforms 117 networked to the central media database 101.

The one or more remote output platforms 118, represented in FIG. 2 as being installed at remote installation site 4, are remotely connected to the central media database 101, for example, via the Internet or other communications network, and allow the remote hosting of multi-media displays on geographically separated installation sites by a single deployment of the system 1.

The manner in which the media assets are stored in the central media database 101 and then served to the output platforms 117 and 118 for display via the media output devices 103 to 106 will now be explained with reference to FIG. 3. The system 1 includes a content manager 119 for uploading of media assets. At step 20, multi-media content or other media assets intended for display at the media output devices 103 to 106 are either created or retrieved from existing sources. At step 21, the content manager 119 is used to select a subset of media assets and a subset of the media programs maintained in the central media database 101 for display at the media output devices 103 to 106. The subset of media assets and the subset of media programs are then assigned by the content manager to one or more of the output platforms 117 and 118.

The system 1 includes an output platform update server 120 and a corresponding output platform manager 121 for controlling the copying of media asset and media program files from the central media database 101 to the output platforms 117 and 118. Specifically, at step 22, the output platform update server 120 determines if the stored subset of media assets and/or media programs maintained in the central media database 101 have been changed when compared to the local copy stored on each output platform 117 and 118, and when a change is detected serves the updated media assets and media programs to the output platforms 117 and 118.

At step 23, the output platform manager 121 provides a capacity for initiating the update of the media programs and media assets on the output platforms 117 and 118. The output platform manager 112 initiates an update request at step 23 with the output platform update server 120 and if the media programs or media assets have been changed then an update of the output platform 117 and 118 will occur.

A file synchronisation manager 122 is provided, running in both server and client modes, to provide a capacity to transfer the media programs and media assets as files from the server hosting the central media database 101 to the local or remote output platforms 117 or 118.

A dynamic display engine 123 is provided to deliver the media output, derived from the subset of media assets and the execution of the subset of media programs, to the one or more media output devices connected to the output platforms 117 or 118. Accordingly, the media output is published to a user audience via the media output devices 103 to 106.

FIG. 4 provides an overview of the software components implementing the media asset management and publication system 1, together with the hardware environment supporting these software elements and the distributed network interconnecting those hardware items. As seen in FIG. 4, the central media database 101 includes a database server 126, and server operating system and associated hardware 201. The combination of functionality provided by the database server and operating system's file system provides the fundamental storage services for the media assets and the media programs for publication of the media assets. The central media database 101 is directly associated with the content manager 119, media content replicator 115, output platform update server 120 and file synchronisation manager server 122 running on the same server hardware as the central media database 101. The content manager 119 is accessible from a browser based user interface 125 running on a workstation operation system and associated hardware 200.

The output platform 117 and 118 include the output platform manager 121 and file synchronisation manager 122 running on a workstation/server operating system and associated server hardware 202. The dynamic display engine 123 delivering media output to the one or more media output devices, and web server 116 for delivering online multi-media content to the Internet, are also supported by the workstation/server operating system and associated hardware 202. A logic control processor 127 runs on a dedicated workstation 207 including workstation/server operating system and associated hardware 204. The logic control processor 127 accepts input from the input devices 111. The logic control processor 127 provides a capacity for integrating automatic sensing devices such as motion detectors, and user input devices such as smart cards within the system 1, and provides a means to initiate multi-media displays based in the input received from the input devices 111. Accordingly, the logic control processor initiates actions performed by the dynamic display engine 123.

The workstation 206 from which the content manager 119 is accessed, central media database 101, output platforms 117 and 118, display devices 103 to 106 and logic control processor 127 are all networked via a distributed network 205.

The dynamic management of the media assets maintained within the central media database 101 is managed by a dynamic content management component 102, including the content manager software 119 shown in FIG. 4. The content manager software 119 includes a number of software components, as shown in FIG. 5. The content manager software manager 119 provides a user access control component 102.1. This component allows a facility to assign different levels of user access to the media assets maintained in the system 1 to different user accounts. A secure access structure may therefore be defined around the media assets to disallow inappropriate access.

Media program component 102.2 provides a capacity for the creation, deletion and modification of complex interactive and non-interactive media programs. This component allows the facility to customise the display of the media assets maintained in the system 1. The media program component 102.2 is customisable in terms of the content of the media assets assigned to the various media programs. The media programs support a hierarchical navigational structure of nodes extending from a root node. A media program node includes a media layout template selected from the media layout template component 102.4, and associated media assets 102.3.

The content manager 119 provides a capacity to add, delete, modify or move media program nodes to or from the media program component 102.2. In addition, the content manager 119 enables the addition or deletion of media assets to or from the system 1. The content manager 119 also provides a capacity to list and search the media assets stored in the system 1 as well as a capacity to assign or unassign media assets to or from media program nodes. Media layout templates in the media layout template component 102.4 provide a framework for situating individual media assets into a node of a media program within the media program component 102.2.

A computer administration component 102.5 enables the creation, deletion and modification of computer references to networked workstation computers. The networked workstation computers fulfil the function of the output platforms 117 and 118. The computer administration component 102.5 provides support for assigning or unassigning media programs to output platforms 117 and 118. This allows the modification of where and when a media program will be run.

A user account administration module 102.6 provides support for the creation, deletion and modification of user accounts with access to the media assets maintained in the system 1.

A usage statistics component 102.7 provides a capacity for the gathering and analysis of usage statistics of the media assets stored in the system 1. This component assists staff in a facility at which the system is installed to modify and adapt the display of the media assets in response to an audience's interaction with the media output devices.

A search utility component 102.8 is provided by the content manager 119 for the fast retrieval, display and extraction of the media assets maintained in the system 1. The search capacity enables the media repository to act as a searchable database of media assets. The search terms including, but are not limited to, keywords associated with the media assets and text searches.

A transactional log component 102.9 records the data, user name, item changed characteristics (such as file path and file name, database object ID, etc), and an optional user comment. The user comment functionality can be selected on by a user, so that a comment prompt appears whenever a user makes a change, or selected off, so that no comment prompt will appear. The default behaviour for the comment prompt is selected on. The transactional log component 102.9 creates a transaction log that is read-only accessible from a transaction log administration screen access from the content manager browser 125. The transactional log may be searched based on date, user name and characteristics of the object that has been changed. A capability is also provided for the automated, periodic compression and archiving of the transaction log to control the amount of disc space that the log may consume. This is also configurable from the transaction log administration screen. There is also provided the capability of assigning a list of users to be notified of the changes to the transactional log.

The process of notification is configurable for a batch time frame. This enables notifications to be sent at discreet time frames, such as every twenty four hours. The notification captures changes made since the last notification was sent. The transactional log component 102.9 also provides a capability of filtering the transactional log for the notification process on user name, or characteristics of the object changed. The administration of the notification process, including assigning or deleting users from the notification list and setting the notification time frame and/or filter is performed from the transactional log administration screen. Notifications may typically be implemented by an off-the-shelf messaging system, sending email, SMS or like notifications.

As previously described, the system 1 supports the simultaneous parallel publishing of media assets maintained in the central media database 101. This allows a single instance of a media asset to be automatically displayed or otherwise published at different resolutions or formats on diverse media output devices. For example, the system 1 automatically adapts an image or text multimedia asset to a display medium, allowing all possible displays to be supported by the storage of a single high resolution instance of an image or text multimedia asset. The media assets are published simultaneously, and in parallel, with the highest possible media production values of the media assets stored by the system 1. This allows facilities to create state of the art multimedia displays utilizing the latest display mediums.

The function of simultaneous parallel publishing is accomplished by the use of a software subcomponent 121.1 in the output platform manager 121. The subcomponent 121.1, known as the MultiFormat subcomponent, automatically produces reformatted versions of user selected text or other media assets. These additional versions are never directly interacted with by the user. They exist only on the output platforms 117, 118 and are served directly to the dynamic display engine 123.

The reformatted versions of the media assets are generated by the use of a software component triggered by a mismatch between the specification of Dynamic Layout Templates for a media output device and the media asset intended to be published at that media output device. The mismatch is detected at the output platform manager 121, whilst the Dynamic Layout Templates specifications are maintained by the dynamic content manager 102.

The steps performed by the system 1 in the simultaneous parallel publishing of media assets at the media output devices are depicted in FIG. 6. At step 300, a user interacts with a single instance of the image or text. (The MultiFormat versions are never seen from the content manager 119.) At step 301, the user uploads a single text or image multimedia item which is then stored in the comprehensive multimedia database 101. At step 302, the output platform manager 121 requests images, text or other media in a specific format relevant for display or publishing. The output update platform server 120 serves the requested image or text in the relevant format at step 303.

The MultiFormat software component 121.1 then reformats the original text, image or other media item at step 304 into a different format for the display at a selected media output device. The dynamic display engine 123 subsequently displays the multimedia items in the appropriate format at step 305.

It will be understood from the foregoing that the multimedia and other media assets include, but are not limited to, instances of images, text, video and audio that can be digitally stored at high resolutions and published at varying resolutions.

Moreover, the use of the term “facility” is intended to include, but not be limited to, a company, organization, institution, etc, for whom the system 1 could be deployed.

The multimedia displays and other media output devices include, but are not limited to, complex interactive programs and non-interactive programs displayed on touch screens, plasma and LCD display screens, video projections, mobile handheld computing devices, mobile telephones, audio terminals and websites.

The above described systems and method for management and publication of media assets in a distributed network provides a mechanism for replication and sharing of multi-media content and other media assets displayed in a complex interactive or non-interactive environment between distributed sites located in participating facilities. Two or more facilities are able to actively collaborate in the creation and hosting of media displays using interactive or non-interactive media programs based on shared multi-media content. Displays can pass from facility to facility with minimal effort, minimising the associated cost of hosting the displays once the system has been deployed.

The system provides a capacity for multiple media displays within a host facility or at a remote facility served from a single deployment of the system. The system also provides for the transparent and simultaneous parallel publishing of individual media assets maintained in a central location from multiple output platforms that provide the processing power required to display the media assets from decentralised locations. The hardware resources required to support interactive multi-media displays are then able to be distributed to various facilities hosting the multi-media displays without over using the hardware resources that support the centralised multi-media storage system.

Finally, it will be understood that various modifications and/or additions may be made to the above described method and system for management and publication of media assets in a distributed network without departing from the ambit of the invention as defined in the claims appended hereto.

1. A system for management and publication of media assets in a distributed network, the system including:
a central media database for storing and serving the media assets and media programs for publication of the media assets;
one or more output platforms networked to the central media database; and
one or more media output devices networked to the one or more output platforms,
each output platform storing a local copy of a subset of the media assets and a subset of the media programs, and selectively executing the subset of media programs to publish the subset of media assets at the one or more media output devices.

2. The system of claim 1, wherein the central media database includes a content manager for uploading the media assets.

3. The system of claim 2, wherein the content manager enables searching and selection of the subset of media assets and the subset of media programs, and the assignment of the subset of media assets and the subset of media programs to the one or more output platforms.

4. The system of claim 2, wherein the content manager is accessible from a browser-baser user interface.

5. The system of claim 1, wherein each of the one or more output platforms includes a dynamic display engine for delivery of media output, derived from the subset of media assets and execution of the subset of media programs, to the one or more media output devices.

6. The system of claim 1, wherein the central media database further includes an output platform update server for determining if the stored subset of the media assets and/or media programs have changed when compared to the local copy stored on each output platform, and, when a change is detected, serving updated media assets and media programs to the one or more output platforms.

7. The system of claim 6, wherein each of the one or more output platforms further includes an output platform manager for initiating a request with the output platform update server to update the locally stored subset of the media assets and/or media programs.

8. The system of claim 7, wherein the output platform manager includes a multiformat subcomponent for producing reformatted versions of the media assets for simultaneous, parallel publication at the media output devices.

9. The system of claim 1, wherein the central media database and the one or more output platforms both include a file synchronisation manager for effecting the serving of media assets and/or media programs between the central media database and the one or more output platforms.

10. The system of claim 1, wherein at least one of the one or more output platforms is a local output platform connected to the central media database from a local installation site.

11. The system of claim 1, wherein at least one of the one or more output platforms is a remote output platform connected to the central media database from a remote installation site.

12. The system of claim 1, wherein the central media database further includes a media asset replicator for sharing stored media assets and/or media programs with a further media asset management and publication system.

13. The system of claim 1, which further includes an external media asset manager connected to the distributed network for providing remote access to the stored media assets.

14. The system of claim 1, which further includes one or more distributed terminals connected to the distributed network for providing local access to the stored media assets.

15. The system of claim 1, which further includes a web server connected to the distributed network for providing web-based access to the stored media assets.

16. The system of claim 15, which further includes a web media extension module, accessible via the web server, for maintaining extended media information about the stored media assets.

17. The system of claim 1, wherein the media assets include any one or more of image, text, video and audio content.

18. The system of claim 1, which further includes automatic sensing devices connected to the distributed network for automated triggering of media publication at the media output devices.

19. The system of claim 18, wherein the automatic sensing devices include any one or more of a motion sensor and pressure pad.

20. The system of claim 1, which further includes user input devices connected to the distributed network to enable user interaction with the published media.

21. The system of claim 20, wherein the user input devices include any one or more of a smart card, touch screen display, handheld computing device, mobile phone and Braille touch pad.

22. A method for management and publication of media assets in a distributed network, the method including the steps of:
(a) storing and serving the media assets and media programs for publication of the media assets in a central media database;
(b) at one or more output platforms networked to the central media database, storing a local copy of a subset of the media assets and a subset of the media programs; and
(c) selectively executing the subset of media programs to publish the subset of media assets at one or more media output devices networked to the one or more output platforms.

23. The method of claim 22, wherein the central media database includes a content manager, the method further including the step of uploading the media assets to the central media database.

24. The method of claim 23, further including the steps of:
enabling searching and selection of the subset of media assets and the subset of media programs from the central media database; and
assigning the subset of media assets and the subset of media programs to the one or more output platforms from the content manager.

25. The method of claim 23, which further includes the step of accessing the content manager from a browser-based user interface.

26. The method of claim 22, wherein each of the one or more output platforms includes a dynamic display engine, the method further including the step of delivering media output, derived from the subset of media assets and execution of the subset of media programs, to the one or more media output devices from the dynamic display engine.

27. The method of claim 22, wherein the central media database further includes an output platform update server, the method further include the steps of:
at the output platform update server, determining if the stored subset of the media assets and/or media programs have changed when compared to the local copy stored on each output platform; and
when a change is detected, serving updated media assets and media programs to the one or more output platforms.

28. The method of claim 27, wherein each of the one or more output platforms further includes an output platform manager, the method further including the step of at the output platform manager, initiating a request with the output platform update server to update the locally stored subset of the media assets and/or media programs.

29. The method of claim 28, which further includes the step of:
producing reformatted versions of the media assets for simultaneous, parallel publication at the media output devices.

30. The method of claim 22, wherein the central media database and the one or more output platforms both include a file synchronisation manager, the method further including the step of effecting the serving of media assets and/or media programs between the central media database and the one or more output platforms from the file synchronisation managers.

31. The method of claim 22, wherein at least one of the one or more output platforms is a local output platform connected to the central media database from a local installation site.

32. The method of claim 22, wherein at least one of the one or more output platforms is a remote output platform connected to the central media database from a remote installation site.

33. The method of claim 22, wherein the central media database further includes a media asset replicator, the method further including the step of the media asset replicator, sharing stored media assets and/or media programs with a further media asset management and publication system.

34. The method of claim 22, which further includes the step of providing remote access to the stored media assets from an external media content manager connected to the distributed network.

35. The method of claim 22, which further includes the step of providing local access to the stored media assets from one or more distributed terminals connected to the distributed network.

36. The method of claim 22, which further includes the step of providing web-based access to the stored media assets from a web server.

37. The method of claim 36, which further includes the step of maintaining extended media information about the stored media assets accessible via the web server from a web media extension module.

38. The method of claim 22, wherein the media assets include any one or more of image, text, video and audio content.

39. The method of claim 22, which further includes the step of automatically triggering media publication at the media output devices from automatic sensing devices connected to the distributed network.

40. The method of claim 39, wherein the automatic sensing devices include any one or more of a motion sensor and pressure pad.

41. The method of claim 22, which further includes the step of enable user interaction with the published media from user input devices.

42. The method of claim 41, wherein the user input devices include any one or more of a smart card, touch screen display, handheld computing device, mobile phone and braille touch pad.
